(19) United States
(12) Patent Application Publication
(10) Pub. No.: US 2013/0121275 A1
(43) Pub. Date: May 16, 2013

(54) METHOD AND APPARATUS FOR ALLOCATING RANDOM ACCESS IDENTIFIER FOR FIXED M2M DEVICE IN WIRELESS COMMUNICATION SYSTEM

(71) Applicant: LG ELECTRONICS INC, Seoul (KR)

(72) Inventors: Gi Won PARK, Anyang-si (KR); Hee Jeong CHO, Anyang-si (KR); Jin Soo CHOI, Anyang-si (KR)

(73) Assignee: LG ELECTRONICS INC., Seoul (KR)

(21) Appl. No.: 13/678,358

(22) Filed: Nov. 15, 2012

Related U.S. Application Data
(60) Provisional application No. 61/560,770, filed on Nov. 16, 2011.

(51) Int. Cl. H04W 8/26

(52) U.S. Cl. CPC H04W 8/26
USPC 370/329

(57) ABSTRACT

A method and apparatus for allocating a random access identifier (RAID) for a fixed machine-to-machine (M2M) device in a wireless communication system is provided. A base station transmits a paging message to the fixed M2M device, the paging message including an M2M group ID (MGID) for the fixed M2M device and including a first contention free RAID for a first fixed M2M device having a first index among a plurality of fixed M2M devices which have the same MGID, and allocates a contention free RAID for the fixed M2M device based on the first contention free RAID.

### CROSS-REFERENCE TO RELATED APPLICATIONS

Pursuant to 35 U.S.C. §119(e), this application claims the benefit of U.S. Provisional Patent Application Ser. No. 61/560,770, filed on Nov. 16, 2011, the contents of which is hereby incorporated by reference herein in its entirety.

### BACKGROUND OF THE INVENTION

1. Field of the Invention

The present invention relates to wireless communications, and more particularly, to a method and apparatus for allocating a random access identifier (RAID) for a fixed machine-to-machine (M2M) device in a wireless communication system.

2. Related Art

The institute of electrical and electronics engineers (IEEE) 802.16e standard was adopted in 2007 as a sixth standard for international mobile telecommunication (IMT)-2000 in the name of ‘WMAN-OFDMA TDD’ by the ITU-radio communication sector (ITU-R) which is one of sectors of the international telecommunication union (ITU). An IMT-advanced system has been prepared by the ITU-R as a next generation (i.e., 4th generation) mobile communication standard following the IMT-2000. It was determined by the IEEE 802.16 working group (WG) to conduct the 802.16m project for the purpose of creating an amendment standard of the existing IEEE 802.16e as a standard for the IMT-advanced system. As can be seen in the purpose above, the 802.16m standard has two aspects, that is, continuity from the past (i.e., the amendment of the existing 802.16e standard) and continuity to the future (i.e., the standard for the next generation IMT-advanced system). Therefore, the 802.16m standard needs to satisfy all requirements for the IMT-advanced system while maintaining compatibility with a mobile WiMAX system conforming to the 802.16e standard.

There is ongoing development on the institute of electrical and electronics engineers (IEEE) 802.16p standard optimized for machine-to-machine (M2M) communication based on the IEEE 802.16e standard and the IEEE 802.16m standard. The M2M communication can be defined as an information exchange performed between a subscriber station and a server or between subscriber stations in a core network without any human interaction. In the IEEE 802.16p standard, there is an ongoing discussion on enhancement of medium access control (MAC) of the IEEE 802.16 standard and a minimum change of an orthogonal frequency division multiple access (OFDMA) physical layer (PHY) in licensed bands. Due to the discussion on the IEEE 802.16p standard, a wide area wireless coverage is required in the licensed band, and a scope of applying automated M2M communication can be increased for an observation and control purpose.

When accessing a network, requirements demanded by many M2M applications are significantly different from requirements for human-initiated or human-controlled network access. The M2M application can include vehicular telematics, healthcare monitoring of bio-sensors, remote maintenance and control, smart metering, an automated service of a consumer device, etc. The requirements of the M2M application can include very lower power consumption, larger numbers of devices, short burst transmission, device tampering detection and reporting, improved device authentication, etc.

When network reentry or location update is requested by using a paging message, instead of performing code ranging, a base station may directly allocate a resource for performing the network reentry or location update to a fixed M2M device. That is, the base station may directly allocate a resource for a ranging request message (i.e., AAI-RNG-REQ)/ranging response message (i.e., AAI-RNG-RSP) to the fixed M2M device. Since the fixed M2M device does not perform the code ranging, the fixed M2M device does not generate a random access identifier (RAID). Therefore, the resource for the AAI-RNG-REQ/RSP message cannot be allocated to the fixed M2M device by receiving a CDMA allocation A-MAP IE which is CRC-masked with the RAID.

Accordingly, there is a need for a method for allocating the RAID to the fixed M2M device.

### SUMMARY OF THE INVENTION

The present invention provides a method and apparatus for allocating a random access identifier (RAID) for a fixed machine-to-machine (M2M) device in a wireless communication system. The present invention provides a method for transmitting a paging message including a first contention free RAID for allocating contention free RAIDs for a plurality of fixed M2M devices implicitly.

In an aspect, a method for allocating a random access identifier (RAID) for a fixed machine-to-machine (M2M) device in a wireless communication system is provided. The method includes transmitting a paging message to the fixed M2M device, the paging message including an M2M group ID (MGID) for the fixed M2M device and including a first contention free RAID for a first fixed M2M device having a first index among a plurality of fixed M2M devices which have the same MGID, and allocating a contention free RAID for the fixed M2M device based on the first contention free RAID.

In another aspect, a base station for allocating a random access identifier (RAID) for a fixed machine-to-machine (M2M) device in a wireless communication system is provided. The base station includes a radio frequency (RF) unit for transmitting or receiving a radio signal, and a processor, operatively coupled to the RF unit, and configured for transmitting a paging message to the fixed M2M device, the paging message including an M2M group ID (MGID) for the fixed M2M device and including a first contention free RAID for a first fixed M2M device having a first index among a plurality of fixed M2M devices which have the same MGID, and allocating a contention free RAID for the fixed M2M device based on the first contention free RAID.

### BRIEF DESCRIPTION OF THE DRAWINGS

FIG. 1 shows a wireless communication system.

FIG. 2 shows basic machine-to-machine (M2M) service system architecture of IEEE 802.16 supporting M2M communication.

FIG. 3 shows advanced machine-to-machine (M2M) service system architecture of IEEE 802.16 supporting M2M communication.

FIG. 4 shows an example of an IEEE 802.16m frame structure.

FIG. 5 shows an example of a method for allocating a contention free RAID for a fixed M2M device according to an embodiment of the present invention.

FIG. 6 shows a block diagram showing wireless communication system to implement an embodiment of the present invention.

### DESCRIPTION OF EXEMPLARY EMBODIMENTS

A technology below can be used in a variety of wireless communication systems, such as code division multiple access (CDMA), frequency division multiple access (FDMA), time division multiple access (TDMA), orthogonal frequency division multiple access (OFDMA), and single carrier frequency division multiple access (SC-FDMA). CDMA can be implemented using radio technology, such as universal terrestrial radio access (UTRA) or CDMA2000. TDMA can be implemented using radio technology, such as global system for mobile communications (GSM)/general packet radio service (GPRS)/enhanced data rates for GSM evolution (EDGE). OFDMA can be implemented using radio technology, such as IEEE 802.11 (Wi-Fi), IEEE 802.16 (WiMAX), IEEE 802-20, or evolved UTRA (E-UTRA). IEEE 802.16m is the evolution of IEEE 802.16e, and it provides a backward compatibility with an IEEE 802.16e-based system. IEEE 802.16p is optimized for machine-to-machine (M2M) communication based on IEEE 802.16e and IEEE 802.16m. UTRA is part of a universal mobile telecommunications system (UMTS). 3rd generation partnership project (3GPP) long term evolution (LTE) is part of evolved UMTS (E-UMTS) using evolved-UMTS terrestrial radio access (E-UTRA), and it adopts OFDMA in downlink (DL) and SC-FDMA in uplink (UL). LTE-A (advanced) is the evolution of 3GPP LTE.

IEEE 802.16m and IEEE 802.16p is chiefly described as an example in order to clarify the description, but the technical spirit of example embodiments of the present invention is not limited to IEEE 802.16m and IEEE 802.16p.

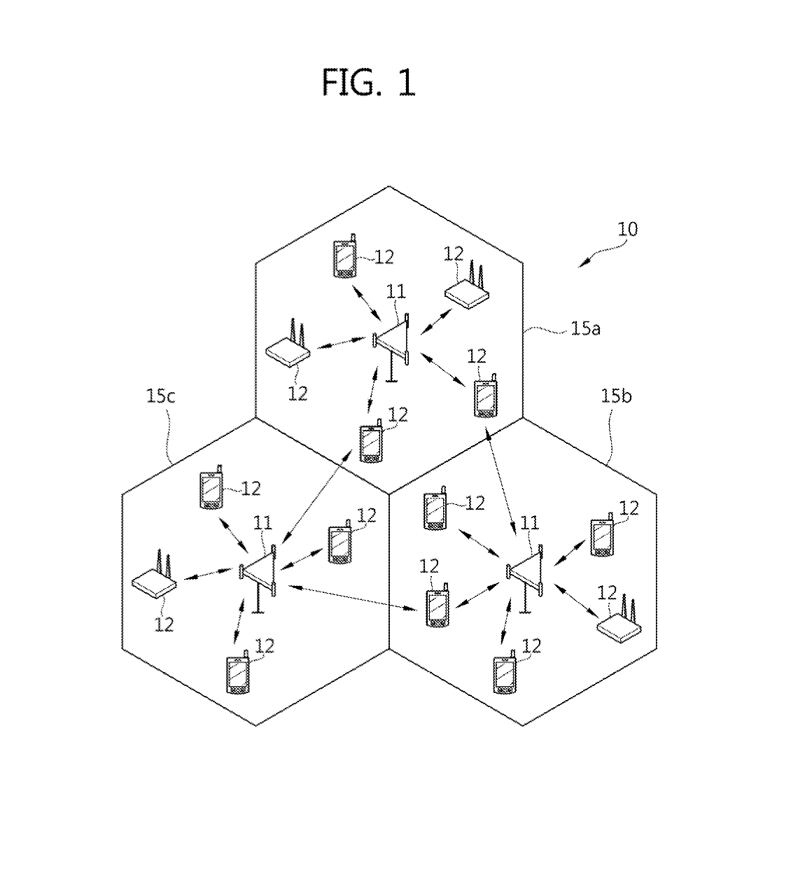

FIG. 1 shows a wireless communication system.

Referring to FIG. 1, the wireless communication system 10 includes one or more base stations (BSs) 11. The BSs 11 provide communication services to respective geographical areas (in general called ‘cells’) 15a, 15b, and 15c. Each of the cells can be divided into a number of areas (called ‘sectors’). A user equipment (UE) 12 can be fixed or mobile and may be referred to as another terminology, such as a mobile station (MS), a mobile terminal (MT), a user terminal (UT), a subscriber station (SS), a wireless device, a personal digital assistant (PDA), a wireless modem, or a handheld device. In general, the BS 11 refers to a fixed station that communicates with the UEs 12, and it may be referred to as another terminology, such as an evolved-NodeB (eNB), a base transceiver system (BTS), or an access point.

The UE generally belongs to one cell. A cell to which a UE belongs is called a serving cell. A BS providing the serving cell with communication services is called a serving BS. A wireless communication system is a cellular system, and so it includes other cells neighboring a serving cell. Other cells neighboring the serving cell are called neighbor cells. A BS providing the neighbor cells with communication services is called as a neighbor BS. The serving cell and the neighbor cells are relatively determined on the basis of a UE.

This technology can be used in the downlink (DL) or the uplink (UL). In general, DL refers to communication from the BS 11 to the UE 12, and UL refers to communication from the UE 12 to the BS 11. In the DL, a transmitter may be part of the BS 11 and a receiver may be part of the UE 12. In the UL, a transmitter may be part of the UE 12 and a receiver may be part of the BS 11.

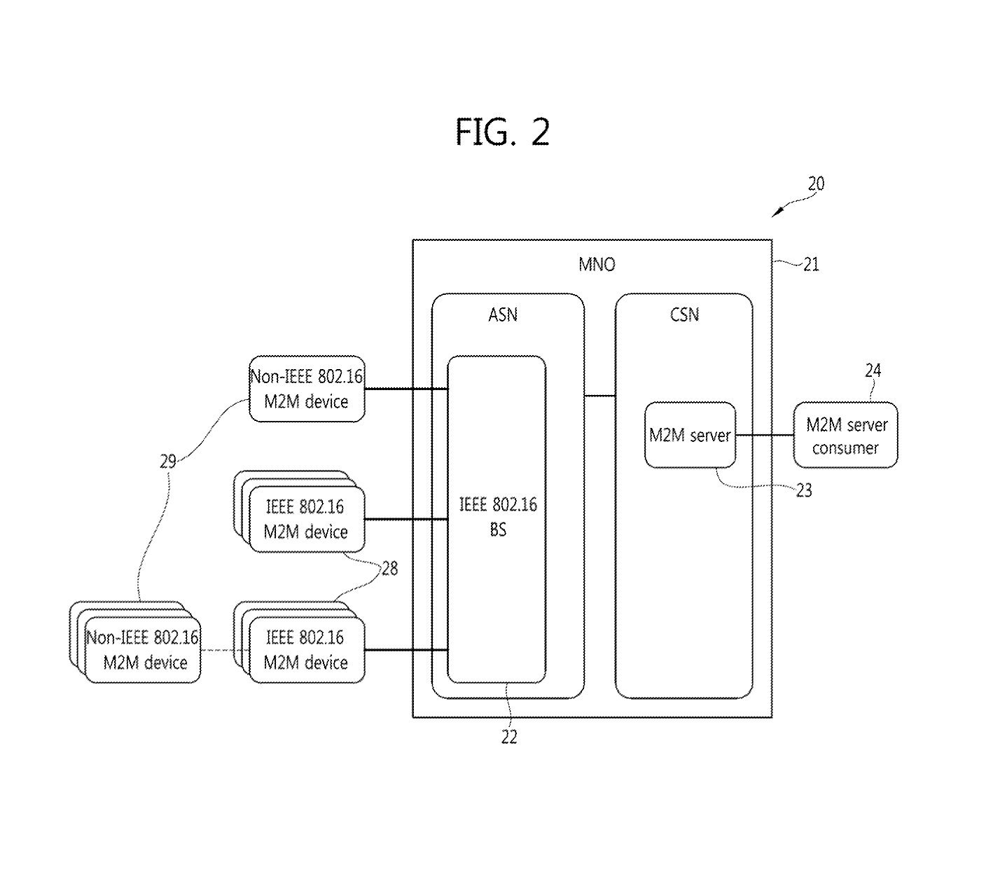

FIG. 2 shows basic machine-to-machine (M2M) service system architecture of IEEE 802.16 supporting M2M communication.

A basic M2M service system architecture 20 includes a mobile network operator (MNO) 21, a M2M service consumer 24, at least one IEEE 802.16 M2M device (hereinafter, 802.16 M2M device) 28, and at least one non-IEEE 802.16 M2M device 29. The MNO 21 includes an access service network (ASN) and a connectivity service network (CSN). The 802.16 M2M device 28 is an IEEE 802.16 mobile station (MS) having a M2M functionality. A M2M server 23 is an entity for communicating with one or more 802.16 M2M devices 28. The M2M server 23 has an interface accessibly by the M2M service consumer 24. The M2M service consumer 24 is a user of a M2M service. The M2M server 23 may be located inside or outside the CSN, and can provide a specific M2M service to the one or more 802.16 M2M devices 28. The ASN may include an IEEE 802.16 base station (BS) 22. A M2M application operates based on the 802.16 M2M device 28 and the M2M server 23.

The basic M2M service system architecture 20 supports two types of M2M communication, i.e., M2M communication between one or more 802.16 M2M devices and a M2M server or point-to-multipoint communication between the 802.16 M2M devices and an IEEE 802.16 BS. The basic M2M service system architecture of FIG. 2 allows the 802.16 M2M device to operate as an aggregation point for a non-IEEE 802.16 M2M device. The non-IEEE 802.16 M2M device uses a radio interface different from IEEE 802.16 such as IEEE 802.11, IEEE 802.15, PLC, or the like. In this case, the non-IEEE 802.16 M2M device is not allowed to change the radio interface to IEEE 802.16.

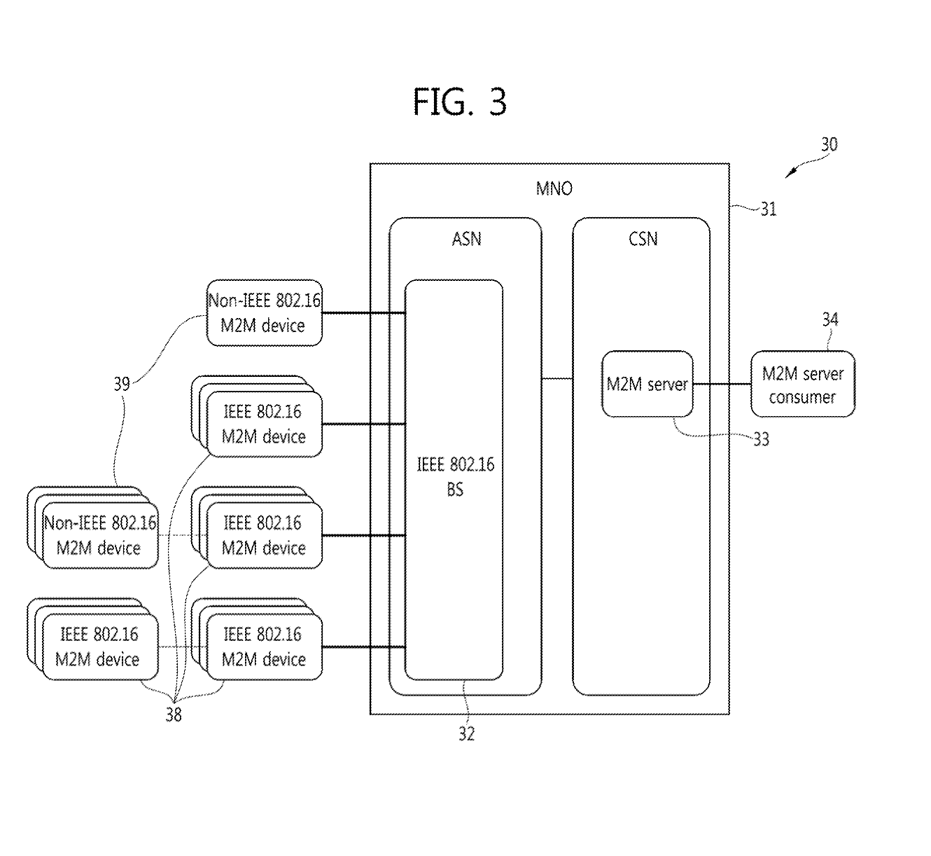

FIG. 3 shows advanced machine-to-machine (M2M) service system architecture of IEEE 802.16 supporting M2M communication.

In the advanced M2M service system architecture, an 802.16 M2M device can operate as an aggregation point for a non-IEEE 802.16 M2M device, and also can operate as an aggregation point for an 802.16 M2M device. In this case, in order to perform an aggregation function for the 802.16 M2M device and the non-802.16 M2M device, the radio interface can be changed to IEEE 802.16. In addition, the advanced M2M service system architecture can support a peer-to-peer (P2P) connection between 802.16 M2M devices. In this case, the P2P connection can be established on either IEEE 802.16 or another radio interface such as IEEE 802.11, IEEE 802.15, PLC, or the like.

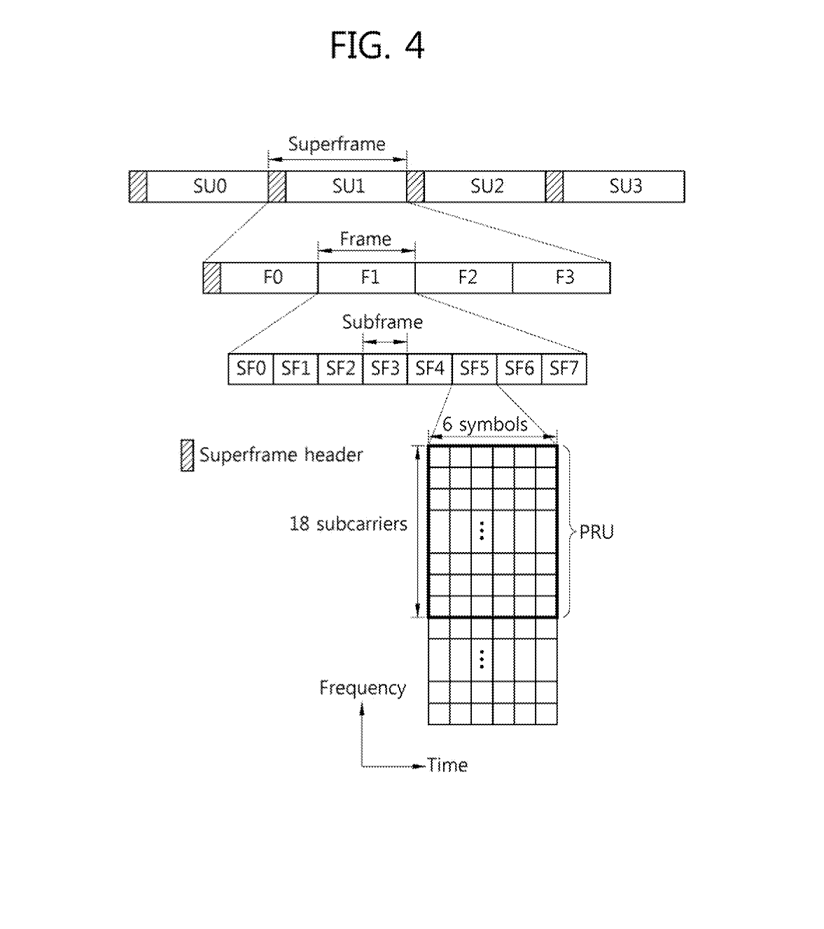

FIG. 4 shows an example of an IEEE 802.16m frame structure.

Referring to FIG. 4, a superframe (SF) includes a superframe header (SFH) and four frames F0, F1, F2, and F3. Each frame may have the same length in the SF. Although it is shown that each SF has a size of 20 milliseconds (ms) and each frame has a size of 5 ms, example embodiments of the present invention is not limited thereto. A length of the SF, the number of frames included in the SF, the number of SFs included in the frame, or the like may change variously. The number of SFs included in the frame may change variously according to a channel bandwidth and a cyclic prefix (CP) length.

One frame includes 8 subframes SF0, SF1, SF2, SF3, SF4, SF5, SF6, and SF7. Each subframe can be used for UL or DL transmission. One subframe includes a plurality of orthogonal frequency division multiplexing (OFDM) symbols or orthogonal frequency division multiple access (OFDMA) symbols in a time domain, and includes a plurality of subcarriers in a frequency domain. An OFDM symbol is for representing one symbol period, and can be referred to as other terminologies such as an OFDMA symbol, an SC-FDMA symbol, etc., according to a multiple access scheme. The subframe can consist of 5, 6, 7, or 9 OFDMA symbols. However, this is for exemplary purposes only, and thus the number of OFDMA symbols included in the subframe is not limited thereto. The number of OFDMA symbols included in the subframe may change variously according to a channel bandwidth and a CP length. A subframe type may be defined according to the number of OFDMA symbols included in the subframe. For example, it can be defined such that a type-1 subframe includes 6 OFDMA symbols, a type-2 subframe includes 7 OFDMA symbols, a type-3 subframe includes 5 OFDMA symbols, and a type-4 subframe includes 9 OFDMA symbols. One frame may include subframes each having the same type. Alternatively, one frame may include subframes each having a different type. That is, the number of OFDMA symbols included in each subframe may be identical or different in one frame. Alternatively, the number of OFDMA symbols included in at least one subframe of one frame may be different from the number of OFDMA symbols of the remaining subframes of the frame.

Time division duplex (TDD) or frequency division duplex (FDD) can be applied to the frame. In the TDD, each subframe is used in UL or DL transmission at the same frequency and at a different time. That is, subframes included in a TDD frame are divided into a UL subframe and a DL subframe in the time domain. In the FDD, each subframe is used in UL or DL transmission at the same time and at a different frequency. That is, subframes included in an FDD frame are divided into a UL subframe and a DL subframe in the frequency domain. UL transmission and DL transmission occupy different frequency bands and can be simultaneously performed.

A superframe header (SFH) can carry an essential system parameter and system configuration information. The SFH may be located in a first subframe in a superframe. The SFH may occupy last 5 OFDMA symbols of the first subframe. The SFH can be classified into a primary-SFH (P-SFH) and a secondary-SFH (S-SFH). The P-SFH may be transmitted in every superframe. Information transmitted on the S-SFH can be divided into 3 sub-packets, i.e., S-SFH SP1, S-SFH SP2, and S-SFH SP3. Each sub-packet can be transmitted periodically with a different periodicity. Information transmitted through the S-SFH SP1, the S-SFH SP2, and the S-SFH SP3 may be different from one another. The S-SFH SP1 may be transmitted with the shortest period, and the S-SFH SP3 may be transmitted with the longest period. The S-SFH SP1 includes information on network re-entry, and a transmission period of the S-SFH SP1 may be 40 ms. The S-SFH SP2 includes information on initial network entry and network discovery, and a transmission period of the S-SFH SP2 may be 80 ms. The S-SFH SP3 includes other important system information, and a transmission period of the S-SFH SP3 may be either 160 ms or 320 ms.

One OFDMA symbol includes a plurality of subcarriers, and the number of subcarriers is determined according to a fast Fourier transform (FFT) size. There are several types of subcarriers. A subcarrier type may include a data subcarrier for data transmission, a pilot subcarrier for various estimations, and a null carrier for a guard band and a DC carrier. A parameter for characterizing an OFDMA symbol includes BW, N_{used}, n, G, etc. BW denotes a nominal channel bandwidth. N_{used} denotes the number of subcarriers in use (including a DC subcarrier). n denotes a sampling factor. This parameter is used to determine a subcarrier spacing and a useful symbol time together with BW and N_{used}. G denotes a ratio of a CP time and a useful time.

Table 1 below shows an OFDMA parameter.

TABLE 1

| Channel bandwidth, BW(MHz) | | | 5 | 7 | 8.75 | 10 | 20 |
|---|---|---|---|---|---|---|---|
| Sampling factor, n | | | 28/25 | 8/7 | 8/7 | 28/25 | 28/25 |
| Sampling frequency, Fₛ(MHz) | | | 5.6 | 8 | 10 | 11.2 | 22.4 |
| FFT size, N_{FFT} | | | 512 | 1024 | 1024 | 1024 | 2048 |
| Subcarrier spacing, Δf(kHz) | | | 10.94 | 7.81 | 9.77 | 10.94 | 10.94 |
| Useful symbol time, T_{b}(μs) | | | 91.4 | 128 | 102.4 | 91.4 | 91.4 |
| G = 1/8 | Symbol time, Tₛ(μs) | | 102.857 | 144 | 115.2 | 102.857 | 102.857 |
| | FDD | Number of | 48 | 34 | 43 | 48 | 48 |
| | | ODFMA symbols | | | | | |
| | | per 5 ms frame | | | | | |
| | | Idle time(μs) | 62.857 | 104 | 46.40 | 62.857 | 62.857 |
| | TDD | Number of | 47 | 33 | 42 | 47 | 47 |
| | | ODFMA symbols | | | | | |
| | | per 5 ms frame | | | | | |
| | | TTG + RTG(μs) | 165.714 | 248 | 161.6 | 165.714 | 165.714 |
| G = 1/16 | Symbol time, Tₛ(μs) | | 97.143 | 136 | 108.8 | 97.143 | 97.143 |
| | FDD | Number of | 51 | 36 | 45 | 51 | 51 |
| | | ODFMA symbols | | | | | |
| | | per 5 ms frame | | | | | |
| | | Idle time(μs) | 45.71 | 104 | 104 | 45.71 | 45.71 |
| | TDD | Number of | 50 | 35 | 44 | 50 | 50 |
| | | ODFMA symbols | | | | | |
| | | per 5 ms frame | | | | | |
| | | TTG + RTG(μs) | 142.853 | 240 | 212.8 | 142.853 | 142.853 |
| G = 1/4 | Symbol time, Tₛ(μs) | | 114.286 | 160 | 128 | 114.286 | 114.286 |
| | FDD | Number of | 43 | 31 | 39 | 43 | 43 |
| | | ODFMA symbols | | | | | |
| | | per 5 ms frame | | | | | |
| | | Idle time(μs) | 85.694 | 40 | 8 | 85.694 | 85.694 |
| | TDD | Number of | 42 | 30 | 38 | 42 | 42 |
| | | ODFMA symbols | | | | | |
| | | per 5 ms frame | | | | | |
| | | TTG + RTG(μs) | 199.98 | 200 | 136 | 199.98 | 199.98 |

| | | | | | | |
|---|---|---|---|---|---|---|
| Number of Guard | Left | 40 | 80 | 80 | 80 | 160 |
| subcarriers | Right | 39 | 79 | 79 | 79 | 159 |

| | | | | | |
|---|---|---|---|---|---|
| Number of used subcarriers | 433 | 865 | 865 | 865 | 1729 |
| Number of PRU in type-1 subframe | 24 | 48 | 48 | 48 | 96 |

In Table 1, N_{FFT} is smallest power of two greater than N_{used}. A sampling factor Fₛ is floor (n·BW/8000)×8000, a subcarrier spacing Δf is Fₛ/N_{FFT}, a useful symbol time T_{b} is 1/Δ, a CP time T_{g} is G·T_{b}, an OFDMA symbol time Tₛ is T_{b}+T_{g}, and a sampling time is T_{b}/N_{FFT}.

Hereinafter, a paging message will be described.

A paging message is a mobile station (MS) notification message which either indicates the presence of DL traffic pending for the specified MS or polls an MS for requesting a location update without requiring a full network entry. The paging message can be broadcast. The Paging message may include the information for multiple MSs. The paging message may include identification of the MSs to be notified of pending DL traffic and location update. The Paging message may also include an action code directing each MS notified via the inclusion of its identifier.

Table 2 shows an example of part of a paging message (i.e., AAI-PAG-ADV message) for the M2M device which is a paging message of IEEE 802.16p.

TABLE 2

| | Size | | |
|---|---|---|---|
| Field | (bit) | Value/Description | Condition |
| . . . | | | |
| For (i=0; i<M; i++) { | | M equals the number of bits in | Present only for M2M |
| | | Paging_Group_IDs bit-map whose bit is set | devices |
| | | to 1. | |
| For (j=0; | | Num_devices indicates the number of paged | |
| j<Num_devices; j++) { | | M2M devices in a corresponding paging | |
| | | group | |
| | | [1 . . . 32] | |
| Deregistration Identifier | 18 | Used to indicate Deregistration ID for the | Present if the S-SFH |
| (DID) | | M2M device to be paged (Deregistration | Network Configuration bit == |
| | | Identifier and Paging Cycle are used to | 0b0 |
| | | identify each paged M2M device) | |
| | | [0 . . . 2¹⁸-1] | |
| MAC Address Hash | 24 | Used to identify the M2M device to be | Present if the S-SFH |
| | | paged | Network Configuration bit == |
| | | | 0b1 |
| Paging Cycle | 4 | Used to indicate Paging cycle for the M2M | Present if the S-SFH |
| | | device to be paged | Network Configuration bit == |
| | | 0x00: 4 superframes | 0b0 |
| | | 0x01: 8 superframes | |
| | | 0x02: 16 superframes | |
| | | 0x03: 32 superframes | |
| | | 0x04: 64 superframes | |
| | | 0x05: 128 superframes | |
| | | 0x06: 256 superframes | |
| | | 0x07: 512 superframes | |
| | | 0x08: 32768 superframes | |
| | | 0x09: 262144 superframes | |
| | | 0x10: 4194304 superframes | |
| | | 0x11-0x15: Reserved | |
| Action Code | 1 | Used to indicate the purpose of the AAI- | |
| | | PAG-ADV message | |
| | | 0b0: perform network reentry | |
| | | 0b1: perform ranging for location update | |
| M2M network access | 2 | Indicate the network access type for M2M | |
| type | | device; | |
| | | 0b00: Resource allocation (i.e., Fixed M2M | |
| | | Ranging Assignment A-MAP offset) for | |
| | | AAI-RNG-REQ | |
| | | 0b01: dedicated ranging channel allocation | |
| | | in AAI-PAG-ADV | |
| | | 0b10: dedicated ranging channel allocation | |
| | | in broad-cast assignment A-MAP IE | |
| | | 0b11: No dedicated ranging channel | |
| IF(M2M network access | | | |
| type==0b00){ | | | |
| Fixed M2M Ranging | | Indicates the offset in units of frames of the | |
| Assignment A-MAP | | Fixed M2M Ranging Assignment A-MAP | |
| offset for AAI-RNG- | | IE for AAI-RNG-REQ message, where the | |
| REQ | | reference point of this offset value is the | |
| | | frame in which the AAI-PAG-ADV is | |
| | | transmitted. | |
| } | | | |
| M2M Report code | 1 | Indication for the M2M device to send the | Present if M2M is supported |
| | | uplink report | |
| | | 0b0: Reserved | |
| | | 0b1: Send uplink report | |
| } // End of for | | | |
| (j=0;j<Num_devices;j++) | | | |
| } // End of for (i=0; i<M; | | | |
| i++) | | | |
| Initial ranging backoff | 4 | Indicate the initial backoff window size for | May be present if there is at |
| start | | M2M devices. This parameter is applied for | least one M2M device that is |
| | | all M2M devices that are instructed to | instructed to perform network |
| | | perform network reentry or location update | reentry or location update by |
| | | by this message. | this message. |
| Ranging backoff window | 1 | 0b0: increasing the ranging backoff window | If Initial ranging backoff start |
| indicator | | size by a factor of 2 per every ranging retry | field is present |
| | | 0b1: decreasing the ranging backoff window | |
| | | size by a factor of 2 per every ranging retry | |
| For (i=0; i<Num_MGID; | | Num_MGID indicates the number of | Shall be included if the BS |
| i++) { | | MGIDs included in this paging message | sends DL multicast data for |
| | | [0 . . . 63] | M2M after transmission of |
| | | | the AAI-PAG-ADV message. |
| MGID | 12 | M2M Group ID | |
| M2M Group Zone Index | 2 | Zone Index corresponding to an M2M | Present if BS is part of more |
| | | GROUP ZONE ID based on the implicit | than one M2M group zone. |
| | | ordering of the M2M GROUP ZONE IDs in | |
| | | the broadcasted message. It is derived based | |
| | | on the implicit ordering of the M2M | |
| | | GROUP ZONE IDs in the AAI-SCD | |
| | | message transmitted by the ABS. | |
| Action Code | 2 | 0b00: Performing network reentry | |
| | | 0b01: Performing location update | |
| | | 0b10: Receiving multicast traffic without | |
| | | requiring network reentry | |
| | | 0b11: MGID re-assignment | |
| If (Action Code == 0b00 | | | |
| or 0b01) { | | | |
| Initial ranging backoff | 4 | Indicate the initial backoff window size for | |
| start | | M2M devices included in this group | |
| M2M network access | 2 | Indicate the network access scheme for | |
| type | | M2M device | |
| | | 0b00: Resource allocation (i.e., Fixed M2M | |
| | | Ranging Assignment A-MAP offset) for | |
| | | AAI-RNG-REQ, This type is only | |
| | | applicable to fixed M2M device (i.e., | |
| | | Localized_Idle_Mode flag was set to 1 at | |
| | | the idle mode initiation). Except fixed M2M | |
| | | device, mobile M2M device shall perform | |
| | | the contention-based ranging. | |
| | | 0b01: dedicated ranging channel allocation, | |
| | | S-RCH | |
| | | 0b10: dedicated ranging channel allocation, | |
| | | NS-RCH | |
| | | 0b11: No dedicated ranging channel | |
| If (M2M network access | | | |
| type | | | |
| == 0b01 \| 0b10) { | | | |
| M2M ranging | 3 | Indicates the subframe index of the | |
| opportunity subframe | | allocated ranging opportunity dedicated for | |
| index | | M2M devices. | |
| Periodicity of the M2M | 3 | Indicates the periodicity of the ranging | |
| ranging | | dedicated for M2M devices. | |
| | | 0b000: transmission in every frame | |
| | | 0b001: transmission in the first frame in | |
| | | every superframe | |
| | | 0b010: transmission in the first frame in | |
| | | every even numbered superframe, i.e., mod | |
| | | (superframe number, 2) = 0 | |
| | | 0b011: transmission in the first frame in | |
| | | every 4th superframe, i.e., mod (superframe | |
| | | number, 4) = 0 | |
| | | [0b100~0b111: Reserved] | |
| } | | | |
| If (M2M network access | | | |
| type | | | |
| == 0b00) { | | | |
| Fixed M2M Ranging | | This parameter indicates the offset in units | |
| Assignment A-MAP start | | of frames that M2M device starts to monitor | |
| offset for AAI-RNG- | | the resource(i.e., Fixed M2M Ranging | |
| REQ | | Assignment A-MAP IE) for the AAI-RNG- | |
| | | REQ message, where the reference point of | |
| | | this offset value is the frame in which the | |
| | | AAI-PAG-ADV is transmitted. | |
| Resource monitor timer | | Time duration that M2M device monitors | |
| | | the resource (i.e., Fixed M2M Ranging | |
| | | Assignment A-MAP IE) for AAI-RNG- | |
| | | REQ message. | |
| } | | | |
| } // End of if (Action | | | |
| code ==0b00 or 0b01) | | | |
| If (Action Code == 0b10) | | | |
| { | | | |
| Multicast transmission | 8 | Least significant8 bits of the frame number | Shall be present when the |
| start time (MTST) | | in which the ABS starts sending DL | MTST needs to be included |
| | | multicast data. | in this message. |
| } | | | |
| If (Action Code == 0b11) | | | |
| { | | | |
| New MGID | 12 | New MGID | |
| } | | | |
| } | | | |
| For (j=0; | | Num_FMDID indicates the number of | Shall be included when the |
| j<Num_FMDID; j++) { | | FMDIDs included in this paging message | BS pages the fixed M2M |
| | | [1 . . . 32] | devices in localized idle |
| | | | mode. |
| Fixed M2M | 16 | Fixed M2M Deregistration ID | |
| Deregistration ID | | | |
| (FMDID) | | | |
| Action Code | 1 | 0: Performing network re entry | |
| | | 1: Performing location update | |
| M2M report code | 1 | Indication for the M2M device to send the | Present if needed |
| | | uplink report | |
| | | 0b1: send uplink report | |
| M2M network access | 2 | Indicate the network access type for M2M | |
| type | | device; | |
| | | 0b00: Resource allocation (i.e., Fixed M2M | |
| | | Ranging Assignment A-MAP offset) for | |
| | | AAI-RNG-REQ | |
| | | 0b01: dedicated ranging channel allocation | |
| | | in AAI-PAG-ADV | |
| | | 0b10: dedicated ranging channel allocation | |
| | | in broad-cast assignment A-MAP IE | |
| | | 0b11: No dedicated ranging channel | |
| If (M2M network access | | | |
| type ==0b00) { | | | |
| Fixed M2M Ranging | | Indicate the offset in units of frames that | |
| Assignment A-MAP | | M2M device starts to monitor the resource | |
| offset for AAI-RNG- | | (i.e., Fixed M2M Ranging Assignment A- | |
| REQ | | MAP IE for AAI-RNG-REQ message is | |
| | | transmit-ted, where the reference point of | |
| | | this offset value is the frame in which the | |
| | | AAI-PAG-ADV is transmitted. | |
| } | | | |
| } // End of for (j=0; | | | |
| j<Num_FMDID; j++) | | | |
| . . . | | | |
| } | | | |

Group paging may be used for M2M devices. For this, M2M group identifier (MGID) along with a zone index of the associated M2M group zone may be included in a paging message instead of an individual identifier to identify the group of M2M devices. Referring to Table 2, AAI-PAG-ADV message includes an MGID field and a M2M Group Zone Index field. The M2M device follows the paging cycle for monitoring both individual paging and group paging.

An M2M group zone is a logical zone comprising of multiple BSs. The M2M group zone is identified by an M2M group zone ID. The M2M group zone ID may be broadcasted in a system configuration descriptor message (AAI-SCD message). The MGID is a 12-bit value that uniquely identifies a downlink multicast service flow shared by a group of M2M devices within an M2M group zone. An M2M device group is addressed using the MGID and the corresponding M2M group zone index. All MGIDs that are assigned to an M2M device belongs to the same M2M group zone.

A FMDID is assigned to a fixed M2M device by the BS during idle mode entry and released during the network reentry. A 16-bit value uniquely identifies a fixed M2M device in domain of the BS. The BS may assign a new FMDID to a fixed M2M device during location update procedure.

The fixed M2M device may receive a fixed M2M ranging assignment A-MAP IE to allocate an AAI-RNG-REQ/RSP message resource for network reentry or location update. The fixed M2M ranging assignment A-MAP IE is used to allocate a ranging channel of the fixed M2M device in an idle mode. The fixed M2M ranging assignment A-MAP IE may be CRC-masked with a DID or FMDID of the fixed M2M device. Table 3 shows an example of the fixed M2M ranging assignment A-MAP IE.

TABLE 3

| Syntax | Size (bit) | Description/Notes |
|---|---|---|
| M2M_Fixed_Ranging_Assignment_A- | | |
| MAP_IE( ) { | | |
| A-MAP IE Type | 4 | |
| Extended Assignment A-MAP IE type | 4 | Fixed M2M Ranging Assignment A-MAP IE |
| M2M Device Identifier type | 1 | 0: DID |
| | | 1: FMDID |
| If (M2M Device Identifier type == 0) { | | |
| MSB 6 bits of Deregistration Identifier | 6 | MSB 6 bits of Deregistration Identifier (DID) |
| (DID) | | |
| Paging Cycle | 4 | Paging cycle |
| } | | |
| If (M2M Device Identifier type == 1) { | | |
| MSB 4 bits of Fixed M2M device | 4 | MSB 4 bits of Fixed M2M device Identifier |
| Identifier (FMDID) | | (FMDID) |
| } | | |
| Uplink/Downlink Indicator | 1 | Indicates whether the following fields are for |
| | | resource assignment in the uplink or in the downlink. |
| | | 0b0: Uplink |
| | | 0b1: Downlink |
| Resource Index | 11 | 512 FFT size: 0 in first 2 MSB bits + 9 bits for |
| | | resource index |
| | | 1024 FFT size: 11 bits for resource index |
| | | 2048 FFT size: 11 bits for resource index |
| | | Resource index includes location and allocation size. |
| Burst Size | 5 | |
| Reserved | 11 | |
| } | | |

Referring to Table 3, the fixed M2M ranging assignment A-MAP IE can be used to allocate a resource for the fixed M2M device. The fixed M2M ranging assignment A-MAP IE may be transmitted in a frame spaced apart by a length of a fixed M2M ranging assignment A-MAP offset for AAI-RNG-REQ field, included in a paging message, from a time point in which the paging message is transmitted.

Hereinafter, a method is described in which an RAID is assigned to a fixed M2M device so as to allocate an AAI-RNG-REQ/RSP message resource by using a CDMA allocation A-MAP IE. That is, in the method described below, when a BS uses a paging message to request the fixed M2M device to perform network reentry or location update, the BS assigns an RAID to the fixed M2M device while avoiding collision with an RAID of an MS which performs contention-based ranging and/or an MS which performs contention-free ranging. The RAID assigned to the fixed M2M device by the BS is hereinafter referred to as a contention free RAID.

Table 4 shows an example of the paging message for allocating the contention free RAID to the fixed M2M device according to an embodiment of the present invention.

TABLE 4

| | Size | | |
|---|---|---|---|
| Field | (bits) | Value/Description | Condition |
| . . . | . . . | . . . | . . . |
| For (i=0; i<M; i++) { | | M equals the number of bits in | Present only for M2M |
| | | Paging_Group_IDs bitmap whose bit is set | devices |
| | | to 1. | |
| For (j=0; | | Num_devices indicates the number of paged | |
| j<Num_devices; j++) { | | M2M devices in a corresponding paging | |
| | | group 1 . . . 32 | |
| Deregistration | 18 | Used to indicate Deregistration ID for M2M | Present if the S-SFH |
| Identifier | | device to be paged (Deregistration Identifier | Network |
| | | and Paging Cycle are used to identify each | Configuration bit == |
| | | paged M2M device) | 0b0 |
| | | 0 . . . 2¹⁸-1 | |
| MAC Address Hash | 24 | Used to identify the M2M device to be | Present if the S-SFH |
| | | paged | Network |
| | | | Configuration bit == |
| | | | 0b1 |
| Paging Cycle | 4 | Used to indicate Paging cycle for the AMS | Present if the S-SFH |
| | | to be paged | Network |
| | | 0x00: 4 superframes | Configuration bit == |
| | | 0x01: 8 superframes | 0b0 |
| | | 0x02: 16 superframes | |
| | | 0x03: 32 superframes | |
| | | 0x04: 64 superframes | |
| | | 0x05: 128 superframes | |
| | | 0x06: 256 superframes | |
| | | 0x07: 512 superframes | |
| | | 0x08: 32768 superframes | |
| | | 0x09: 262144 superframes | |
| | | 0x10: 4194304 superframes | |
| | | 0x1108-0x15: Reserved | |
| Action Code | 1 | Used to indicate the purpose of the AAI- | |
| | | PAG-ADV message | |
| | | 0b0: perform network reentry | |
| | | 0b1: perform ranging for location update | |
| M2M network access | 2 | Indicate the network re-entry type for M2M | |
| type | | device; | |
| | | 0b00: Resource allocation (i.e., Assignment | |
| | | A-MAP offset) for AAI-RNG-REQ | |
| | | 0b01: dedicated ranging channel allocation | |
| | | in AAI-PAG-ADV | |
| | | 0b10: dedicated ranging channel allocation | |
| | | in broadcast assignment A-MAP IE | |
| | | 0b011: No dedicated ranging channel | |
| If (M2M network | | | |
| access type == 0b00) { | | | |
| Contention free | 15 | Contention Free RAID | |
| RAID | | | |
| } | | | |
| M2M Report code | 1 | Indication for the M2M device to send the | Present if M2M is |
| | | uplink report | supported |
| | | 0b0: reserved | |
| | | 0b1: Send uplink report | |
| } // End of for | | | |
| (j=0;j<Num_devices;j++ | | | |
| ) | | | |
| } // End of for | | | |
| (i=0;i<M;i++) | | | |
| Initial ranging backoff start | 4 | Indicate the initial backoff window size for | May be present if |
| | | M2M devices. This parameter is applied for | there is at least one |
| | | all M2M devices which are instructed to | M2M device which is |
| | | perform network reentry or location update | instructed to perform |
| | | by this message. | network reentry or |
| | | | location update by this |
| | | | message. |
| Ranging backoff window | 1 | 0b0: increasing the ranging backoff window | If initial ranging |
| indicator | | size by a factor of 2 per every ranging entry | backoff start field is |
| | | 0b1: decreasing the ranging backoff window | present |
| | | size by a factor of 2 per every ranging entry | |
| | | as described in 6.2.18.7.2 | |
| For (i=0; i<Num_MGID; | | Num_MGID indicates the number of | Shall be included if |
| i++) { | | MGIDs included in this paging message | the ABS sends DL |
| | | [0 . . . 63] | multicast data for |
| | | | M2M after |
| | | | transmission of the |
| | | | AAI-PAG-ADV |
| | | | message. |
| MGID | 15 | M2M Group ID | |
| Action code | 2 | 0b00: Performing network reentry | |
| | | 0b01: Performing location update | |
| | | 0b10: Receiving multicast traffic without | |
| | | requiring network reentry | |
| | | 0b11: MGID re-assignment | |
| Initial ranging backoff start | 4 | Indicate the initial backoff window size for | |
| | | M2M devices included in this group | |
| If(Action code ==0b00\| | | | |
| 0b01) { | | | |
| M2M network access type | 2 | Indicate the network access scheme for | |
| | | M2M device | |
| | | 0b00: Resource allocation (i.e., Assignment | |
| | | A-MAP offset) for AAI-RNG-REQ, This | |
| | | type is only applicable to fixed M2M device | |
| | | (i.e., Localized_Idle_Mode_Accept flag was | |
| | | set to 1 at the idle mode initiation.). Except | |
| | | fixed M2M device, Mobile M2M device | |
| | | shall perform the contention-based ranging. | |
| | | 0b01: dedicated ranging channel allocation, | |
| | | S-RCH | |
| | | 0b10: dedicated ranging channel allocation, | |
| | | NS-RCH | |
| | | 0b11: No dedicated ranging channel | |
| If (M2M network access type | | | |
| == 0b01 \| 0b10) { | | | |
| M2M ranging opportunity | 3 | Indicates the subframe index of the allocated | |
| subframe index | | ranging opportunity dedicated for M2M | |
| | | devices. | |
| Periodicity of the M2M | 3 | Indicates the periodicity of the ranging | |
| ranging | | dedicated for M2M devices. | |
| | | 0b000: transmission in every frame | |
| | | 0b001: transmission in the first frame in | |
| | | every superframe | |
| | | 0b010: transmission in the first frame in | |
| | | every even numbered superframe, i.e., | |
| | | mod(superframe number, 2) = 0 | |
| | | 0b011: transmission in the first frame in | |
| | | every 4th superframe, i.e., mod(superframe | |
| | | number, 4) = 0 | |
| | | [0b100~0b111: Reserved] | |
| } | | | |
| if (M2M network access type | | | |
| == 0b00) { | | | |
| Contention free CDMA | TBD | The ABS assigns contention free RAID in | |
| Allocation A-MAP IE offset | | a superframe spaced apart by | |
| | | “Contention free CDMA Allocation A- | |
| | | MAP IE offset” from a reference point. | |
| | | The AMS monitors CDMA Allocation A- | |
| | | MAP IE in a superframe spaced apart by | |
| | | “Contention free CDMA Allocation A- | |
| | | MAP IE offset” from a reference point. | |
| | | Reference point: superframe which | |
| | | transmits CDMA Allocation A-MAP IE to | |
| | | allocate a resource for AAI-RNG-REQ | |
| | | message transmission of a paged AMS. | |
| First contention free RAID | 15 | Contention free RAID of a fixed M2M | |
| | | device with index 1 belonging to an MGID | |
| | | member to be group-paged (i.e., a fixed | |
| | | M2M device with index 1 belonging to an | |
| | | MGID). | |
| | | “MGID member index for fixed M2M | |
| | | device” is assigned together when the | |
| | | ABS assigns MGID to the AMS by using | |
| | | an AAI-DSA-REQ message. | |
| Last contention free RAID | 15 | It indicates RAID of the last member | Shall be included |
| | | belonging to the MGID to be group- | when only 1 M2M |
| | | paged. | group is group- |
| | | | paged, and when it is |
| | | | group-paged by |
| | | | including 1 or more |
| | | | MGIDs, shall be |
| | | | included in the last |
| | | | MGID loop. |
| } | | | |
| } End of if (Action code | | | |
| ==0b00 \| 0b01) | | | |
| If(Action Code == 0b10) { | | | |
| Multicast Transmission Start | 8 | Least significant 8 bits of the frame number | Shall be present when |
| Time (MTST) | | in which the ABS starts sending DL | the MTST needs to be |
| | | multicast data. | included in this |
| | | | message. |
| } | | | |
| If(Action Code == 0b11) { | | | |
| New MGID | 15 | | |
| Current FID | 4 | | |
| New FID | 4 | | |
| } | | | |
| } | | | |
| . . . | . . . | . . . | . . . |

Referring to Table 4, the paging message according to the embodiment of the present invention may include a contention free RAID field, a contention free CDMA Allocation A-MAP IE offset field, a first contention free RAID field, and a last contention free RAID field. The paging message according to the embodiment of the present invention may further include a field not shown in Table 4, or may not include the field shown in Table 4.

If a value of the M2M network access type field is Ob00, that is, if a type of the network re-entry of the M2M device is the resource allocation for AAI-RNG-REQ message, the paging message according to the embodiment of the present invention may include a 15-bit contention free RAID. Accordingly, the contention free RAID can be allocated to the fixed M2M device.

Meanwhile, group paging may be performed by using the paging message of Table 4 as described above. The BS may perform the group paging on the basis of an MGID instead of an identifier of an individual M2M device. In this case, if the contention free RAID is allocated to all fixed M2M devices having the same MGID, a paging overhead may be increased by (the number of fixed M2M devices having the same MGID×15 bits (i.e., the length of the contention free RAID)).

Therefore, the paging message according to the embodiment of the present invention may include a first contention free RAID field. The first contention free RAID field may be used to implicitly allocate the contention free RAID to the plurality of fixed M2M devices. The first contention free RAID field indicates a contention free RAID of a fixed M2M device having a first member index among a plurality of fixed M2M devices having the same MGID. Contention free RAIDs of the remaining fixed M2M devices having the same MGID may be implicitly allocated by being incremented by 1 in the order of an MGID member index of fixed M2M device. When the group paging is used to allocate the contention free RAIDs to the fixed M2M devices, only the first contention free RAID may be allocated so that the contention free RAIDs are allocated to all fixed M2M devices having the same MGID.

The MGID member index for fixed M2M device may be assigned by using a dynamic service addition request message (i.e., AAI-DSA-REQ). The MGID member index for fixed M2M device may be assigned to reduce an overhead of the paging message when the contention free RAIDs are allocated to the fixed M2M devices by using the group paging. Table 5 shows an example of the AAI-DSA-REQ message including the MGID member index for fixed M2M device.

TABLE 5

| | Size | | |
|---|---|---|---|
| Field | (bits) | Value/Description | Condition |
| . . . | . . . | . . . | . . . |
| MGID | 12 | | |
| “MGID member | TBD | Member index of | “MGID member |
| index for | | fixed M2M device | index for fixed M2M |
| fixed M2M device” | | belonging to MGID. | device” is assigned |
| | | | together when the |
| | | | ABS assigns MGID |
| | | | to the AMS by using |
| | | | the AAI-DSA-REQ |
| | | | message. |
| . . . | . . . | . . . | . . . |

Referring to Table 5, the MGID member index for fixed M2M device field indicates a member index of fixed M2M devices having the same MGID. The MGID member index for fixed M2M device may be assigned together by using the AAI-DSA-REQ message when the BS assigns the MGID to the fixed M2M device.

Alternatively, the MGID member index for fixed M2M device may be assigned in an idle mode initiation process. That is, the MGID member index for fixed M2M device may be assigned by using a deregistration response message (i.e., AAI-DREG-RSP). Table 6 shows an example of the AAI-DREG-RSP message including the MGID member index for fixed M2M device.

TABLE 6

| | Size | | |
|---|---|---|---|
| Field | (bits) | Value/Description | Condition |
| . . . | . . . | . . . | . . . |
| MGID | 12 | | |
| “MGID member index for | TBD | Member index | |
| fixed M2M device” | | of fixed M2M device | |
| | | belonging to MGID. | |
| . . . | . . . | . . . | . . . |

Referring to Table 6, the AAI-DREG-RSP message includes the MGID member index for fixed M2M device field. The fixed M2M device can know that its contention free RAID is a value obtained by increasing a first contention free RAID by its MGID member index for fixed M2M device.

Referring back to Table 4, the paging message according to the embodiment of the present invention may include a last contention free RAID field. The last contention free RAID field indicates a last contention free RAID assigned by the BS to a fixed M2M device to be group-paged. If one or more MGIDs are present, the last contention free RAID field may be included only in a loop for a last MGID. That is, if a current MGID is not the last MGID, the fixed M2M device can implicitly know that (first contention free RAID-1) of a next MGID is an RAID of a last member of the current MGID.

Alternatively, when the BS assigns an FMDID to a fixed M2M device which enters a localized idle mode, contention free RAIDs may be assigned in sequence. For example, if a fixed M2M device to which FMDID=0 is assigned confirms a first contention free RAID, the device can know that the first contention free RAID is a contention free RAID assigned to itself since the device has a first FMDID. A fixed M2M device to which FMDID=1 is assigned can know that a contention free RAID assigned to itself is first contention free RAID+1.

Meanwhile, fixed M2M devices to which DIDs are assigned and fixed M2M devices to which FMDIDs are assigned and which enter the localized idle mode may belong to one M2M group. When RAIDs are assigned to the fixed M2M devices to which the DIDs are assigned and the fixed M2M devices to which the FMDIDs are assigned, the RAIDs may be assigned to the fixed M2M devices to which the FMDIDs are assigned, by incrementing the RAIDs by 1 from a first contention free RAID and may be assigned to the fixed M2M device to which the DIDs are assigned, by decrementing the RAIDs by 1 from a last contention free RAID. Accordingly, if paging is performed on the M2M group including the fixed M2M devices to which the DIDs are assigned and the fixed M2M devices to which the FMDIDs are assigned, RAID collision can be prevented between the M2M group including the fixed M2M devices to which the DIDs are assigned and the fixed M2M devices to which the FMDIDs are assigned.

Hereinafter, a method is described for determining a time point in which a contention free RAID for a fixed M2M device is assigned so as to prevent an RAID of an MS which performs the conventional contention-based ranging and/or an MS which performs contention-free ranging from colliding with the contention free RAID of the fixed M2M devices.

1) A BS may assign contention free RAIDs to fixed M2M devices in a time point corresponding to (current superframe+1 superframe or N offset superframe). In this case, the current superframe may be a superframe number which transmits a CDMA allocation A-MAP IE for allocating a resource for AAI-RNG-REQ message transmission of a paged MS. Alternatively, the current superframe may be a superframe in which the fixed M2M device will receive a paging message. An offset N may be indicated by the contention free CDMA allocation A-MAP IE offset field included in the paging message of Table 4. The fixed M2M device may monitor the CDMA allocation A-MAP IE in a superframe spaced apart by the contention free CDMA allocation A-MAP IE offset from the current superframe. Accordingly, the contention free RAIDs assigned to the fixed M2M devices can be prevented from colliding with RAIDs assigned to the existing MSs.

A time point in which the contention free RAID is assigned is expressed by Equation 1 below.

RAID(SFN)>{current(SFN)+1 superframe} or

RAID(SFN)>{current(SFN)+Contention free CDMA Allocation A-MAP IE offset} [Equation 1]

2) Alternatively, the ranging process shall be terminated within 128 frames after the MS transmits the ranging code. That is, the contention free RAID assigned to the fixed M2M device may be valid during 128 frames. Accordingly, the BS may assign the contention free RAID to the fixed M2M devices such that the contention free RAID is valid during 128 frames in a time point corresponding to (current superframe+1 superframe or N offset superframe). In this case, the current superframe may be a superframe number which transmits a CDMA allocation A-MAP IE for allocating a resource for AAI-RNG-REQ message transmission of a paged MS. Alternatively, the current superframe may be a superframe in which the fixed M2M device will receive a paging message.

A time point in which the contention free RAID is assigned is expressed by Equation 2 below.

RAID(SFN,FN)>{current(SFN,FN)+(1 superframe or N offset)+128 frame} [Equation 2]

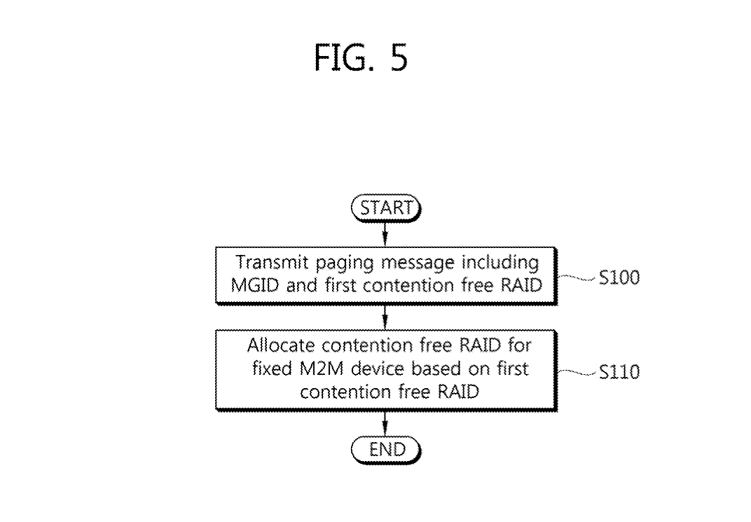

FIG. 5 shows an example of a method for allocating a contention free RAID for a fixed M2M device according to an embodiment of the present invention.

At step S100, a base station transmits a paging message to the fixed M2M device. The paging message may be a paging message described in Table 4 above. The paging message may include an M2M group ID (MGID) for the fixed M2M device. The paging message may include a first contention free RAID for a first fixed M2M device having a first index among a plurality of fixed M2M devices which have the same MGID. At step S110, the base station allocates a contention free RAID for the fixed M2M device based on the first contention free RAID.

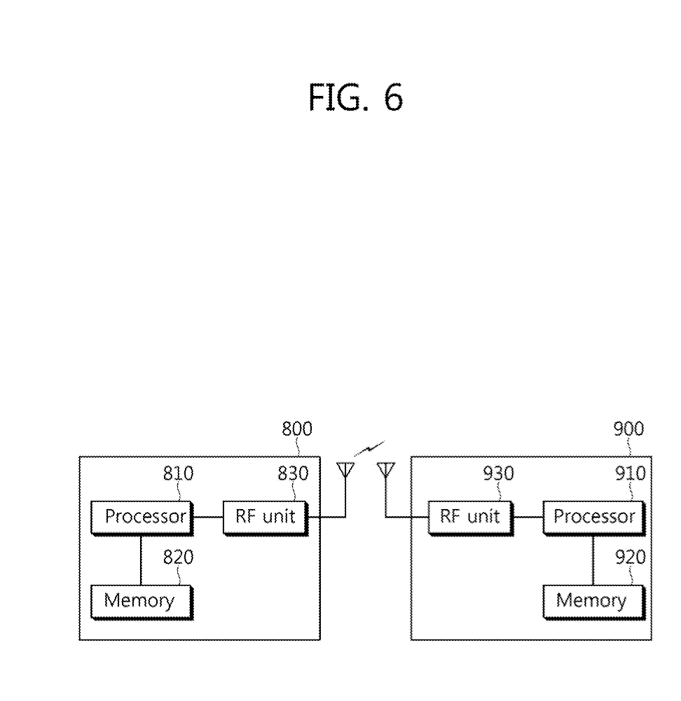

FIG. 6 shows a block diagram showing wireless communication system to implement an embodiment of the present invention.

A BS 800 may include a processor 810, a memory 820 and a radio frequency (RF) unit 830. The processor 810 may be configured to implement proposed functions, procedures and/or methods described in this description. Layers of the radio interface protocol may be implemented in the processor 810. The memory 820 is operatively coupled with the processor 810 and stores a variety of information to operate the processor 810. The RF unit 830 is operatively coupled with the processor 810, and transmits and/or receives a radio signal.

An M2M device 900 may include a processor 910, a memory 920 and a RF unit 930. The processor 910 may be configured to implement proposed functions, procedures and/or methods described in this description. Layers of the radio interface protocol may be implemented in the processor 910. The memory 920 is operatively coupled with the processor 910 and stores a variety of information to operate the processor 910. The RF unit 930 is operatively coupled with the processor 910, and transmits and/or receives a radio signal.

The processors 810, 910 may include application-specific integrated circuit (ASIC), other chipset, logic circuit and/or data processing device. The memories 820, 920 may include read-only memory (ROM), random access memory (RAM), flash memory, memory card, storage medium and/or other storage device. The RF units 830, 930 may include baseband circuitry to process radio frequency signals. When the embodiments are implemented in software, the techniques described herein can be implemented with modules (e.g., procedures, functions, and so on) that perform the functions described herein. The modules can be stored in memories 820, 920 and executed by processors 810, 910. The memories 820, 920 can be implemented within the processors 810, 910 or external to the processors 810, 910 in which case those can be communicatively coupled to the processors 810, 910 via various means as is known in the art.

Contention free RAIDs for fixed M2M devices are efficiently allocated without a paging message overhead.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope and spirit of the present disclosure.

What is claimed is:

1. A method for allocating a random access identifier (RAID) for a fixed machine-to-machine (M2M) device in a wireless communication system, the method comprising:
transmitting a paging message to the fixed M2M device, the paging message including an M2M group ID (MGID) for the fixed M2M device and including a first contention free RAID for a first fixed M2M device having a first index among a plurality of fixed M2M devices which have the same MGID; and
allocating a contention free RAID for the fixed M2M device based on the first contention free RAID.

2. The method of claim 1, further comprising an M2M member index for the fixed M2M device to the fixed M2M device, and
wherein the contention free RAID for the fixed M2M device is allocated based on the M2M member index for the fixed M2M device.

3. The method of claim 2, wherein the contention free RAID for the fixed M2M device is allocated according to Equation (the first contention free RAID+the M2M member index for the fixed M2M device).

4. The method of claim 2, wherein the M2M member index for the fixed M2M device is transmitted through in a dynamic service addition request message (AAI-DSA-REQ).

5. The method of claim 2, wherein the M2M member index for the fixed M2M device is transmitted through in a deregistration response message (AAI-DREG-RSP).

6. The method of claim 1, wherein the contention free RAID for the fixed M2M device is allocated based on a fixed M2M deregistration ID (FMDID) of the fixed M2M device.

7. The method of claim 1, wherein the paging message further includes a last contention free RAID for a last fixed M2M device having a last index among the plurality of fixed M2M devices which have the same MGID.

8. The method of claim 7, further comprising:
allocating contention free RAIDs for a first plurality of fixed M2M devices to which FMDIDs are assigned based on the first contention free RAID; and
allocating contention free RAIDs for a second plurality of fixed M2M devices to which DIDs are assigned based on the last contention free RAID.

9. The method of claim 1, wherein the contention free RAID is allocated in a superframe which is located at one super frame or offset superframe apart from a current superframe.

10. The method of claim 9, wherein the offset superframe is included in the paging message.

11. The method of claim 9, wherein the contention free RAID is valid for 128 frame from the superframe which is located at one super frame or offset superframe apart from a current superframe.

12. The method of claim 9, wherein the current superframe is a superframe in which a CDMA allocation A-MAP IE (information element) for allocating resources for transmission of a ranging request message is transmitted.

13. The method of claim 9, wherein the current superframe is a superframe in which the paging message is transmitted.

14. A base station for allocating a random access identifier (RAID) for a fixed machine-to-machine (M2M) device in a wireless communication system, the base station comprising:
a radio frequency (RF) unit for transmitting or receiving a radio signal; and
a processor, operatively coupled to the RF unit, and configured for:
transmitting a paging message to the fixed M2M device, the paging message including an M2M group ID (MGID) for the fixed M2M device and including a first contention free RAID for a first fixed M2M device having a first index among a plurality of fixed M2M devices which have the same MGID; and
allocating a contention free RAID for the fixed M2M device based on the first contention free RAID.

15. The base station of claim 14, further comprising an M2M member index for the fixed M2M device to the fixed M2M device, and
wherein the contention free RAID for the fixed M2M device is allocated based on the M2M member index for the fixed M2M device.

16. The base station of claim 15, wherein the contention free RAID for the fixed M2M device is allocated according to Equation (the first contention free RAID+the M2M member index for the fixed M2M device).

17. The base station of claim 15, wherein the M2M member index for the fixed M2M device is transmitted through in a dynamic service addition request message (AAI-DSA-REQ).

18. The base station of claim 15, wherein the M2M member index for the fixed M2M device is transmitted through in a deregistration response message (AAI-DREG-RSP).

19. The base station of claim 14, wherein the contention free RAID for the fixed M2M device is allocated based on a fixed M2M deregistration ID (FMDID) of the fixed M2M device.

20. The base station of claim 14, wherein the contention free RAID is allocated in a superframe which is located at one super frame or offset superframe apart from a current superframe.
